(19) United States
(12) Patent Application Publication
(10) Pub. No.: US 2005/0159683 A1
(43) Pub. Date: Jul. 21, 2005

(54) Arm circulation system stretching, recuperative chest enlargement and respiration assistance apparatus

(76) Inventor: Hsin-Chih Kuo, Changhua Hsien (TW)

Correspondence Address: TROXELL LAW OFFICE PLLC, 5205 LEESBURG PIKE, SUITE 1404, FALLS CHURCH, VA, 22041, US

(21) Appl. No.: 10/760,287

(22) Filed: Jan. 21, 2004

(51) Int. Cl. A61H 1/02; A61H 31/00

(52) U.S. Cl. 601/5; 601/24; 601/33; 601/41

(57) ABSTRACT

An arm circulation system stretching, recuperative chest enlargement and respiration assistance apparatus consisting of a swinging appendage disposed at each of the two sides capable of synchronously ascending and descending at a slow rate. The speed of the swing is controlled by the user in a supine position whose arms are spread out on the swinging appendages and holding a remote controller in the palm to control the forward/reverse rotation of the speed reduction motor driving the swinging appendages as well as the upward and downward position of a sleeve on the drive motor screw rod. As such, control is enabled over the ascending and descending angle and speed of the two swinging appendages movably linked to the two sides of the sleeve according to user requirements via remote control which, furthermore, supports the adjustment of the swinging appendages to the desired angle of horizontal posturing, thereby effectively stretching the circulatory system of the arms, while also providing for chest enlargement and respiratory exercises.

### BACKGROUND OF THE INVENTION

1) Field of the Invention

The invention herein relates to physical fitness equipment, specifically an arm circulation system stretching, recuperative chest enlargement and respiration assistance apparatus that provides swinging appendages and which afford control over the angle and speed of swinging appendage articulation according to user requirements to achieve natural chest enlargement and respiratory exercise at the same time.

2) Description of the Prior Art

Conventional physical fitness equipment are numerous and can be categorized according to the physical fitness function needed such as chest enlargement and pull-type exercise apparatus. However, each type of the physical fitness equipment must take into account the strength of the user before the said chest enlargement and pulling exercises are effective. The said chest enlargement and pull-type exercise physical fitness apparatus are equipment used in gyms and have adjustable weights, the users of which build muscles while performing stretching exercises.

### SUMMARY OF THE INVENTION

I. Solved Problems

1. Conventional physical fitness equipment utilize weights to adjust force exertion. The said stretching or chest enlargement requires that the user apply greater or lesser amounts of strength sufficient to pull the weight and, furthermore, muscles are readily susceptible to strain injuries.

2. The said physical fitness regimen is strenuous and the main result is more robust muscles, with the stretching providing virtually no benefit for the blood circulation system, not to mention respiratory development—both of which cannot be significantly improved by physical fitness equipment—and if an excessive amount of weight is used in order to do so by such a forced, unnatural means, the risk of internal injury is very high.

II. Method of Solution

1. The invention herein utilizes a mechanical apparatus having a swinging appendage movably mounted on each of its two sides, each said swinging appendage is linked to a sleeve and, furthermore, the said sleeve is fastened onto a screw rod utilizing a powering speed reduction motor for forward/reverse control such that the screw rod shifts the sleeve upward and downward, simultaneously causing the two swinging appendages to ascend and descend; when the user lies on a bed with the head resting on the pillow of the apparatus body in a relaxed and natural posture, the user spreads out the arms on the swinging appendages and personally controls the articulatory angle and speed of the swinging appendages to thereby stretch the circulatory system of the arms as well as perform chest enlargement and respiratory exercises.

2. The invention herein utilizes the said swinging appendages in an adjustable horizontal angular arrangement to accommodate the swinging appendage positions desired by the user, thereby providing for omnidirectional positioning utilization requirements.

### BRIEF DESCRIPTION OF THE DRAWINGS

FIG. 1 is an exploded drawing of the invention herein.

FIG. 2 is an isometric drawing of the invention herein.

FIG. 3-A is a cross-sectional drawing of the invention herein that illustrates operation.

FIG. 3-B is a cross-sectional drawing of the invention herein that illustrates operation.

FIG. 4 is an orthographic drawing of another embodiment of the invention herein.

### DETAILED DESCRIPTION OF THE INVENTION

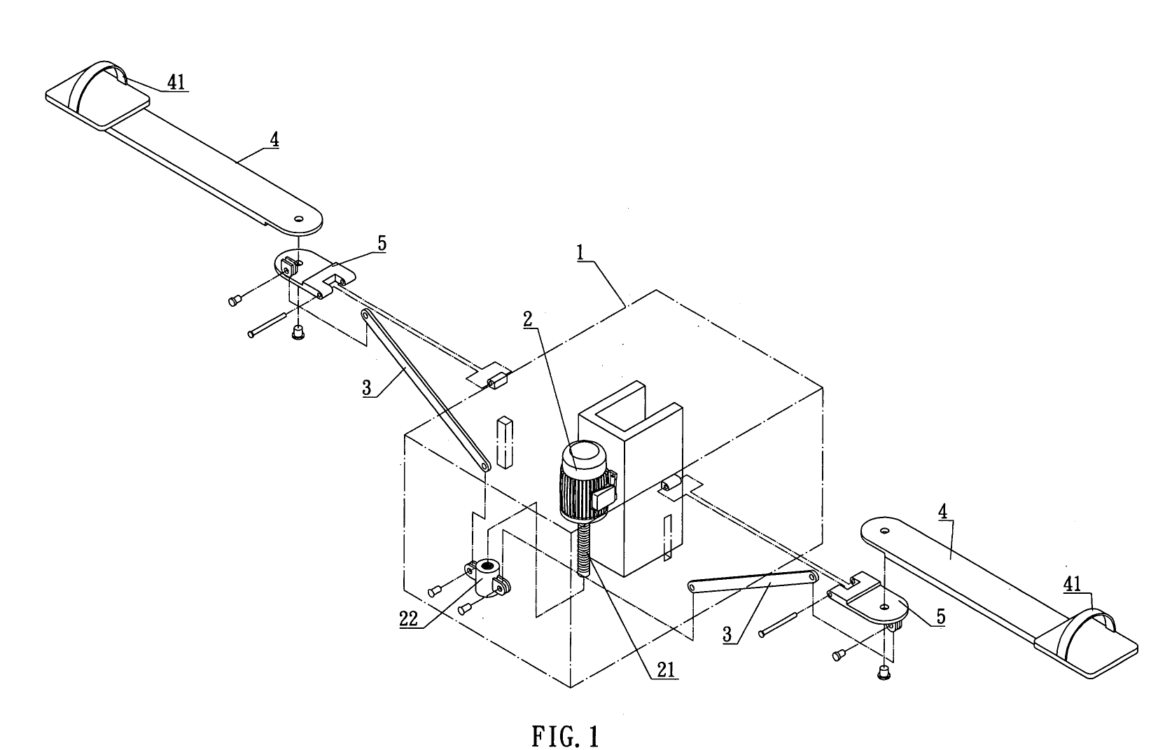

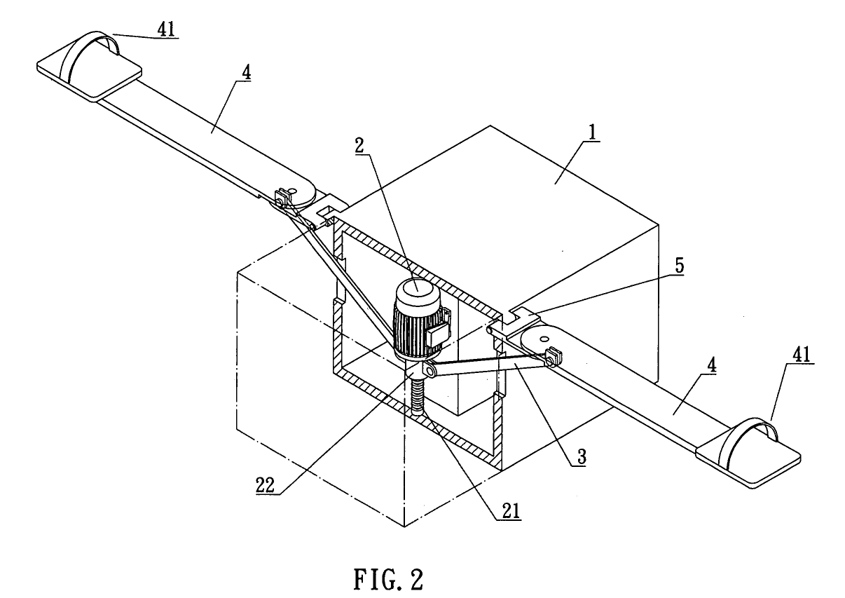

Referring to FIG. 1 and FIG. 2, the invention herein consists of a speed reduction motor 2 installed in the interior section of the apparatus body 1, a screw rod 21 disposed on the drive shaft of the said speed reduction motor 2, a sleeve 22 slipped onto the said screw rod 21, and a support rod 3 movably linked to each of the two sides of the said sleeve 22; each said support rod 3 is extended and movably coupled to a swinging appendage 4, each said swinging appendage 4 is affixed onto a hinge 5, and the said two hinges are each mounted on the two sides of the apparatus body 1.

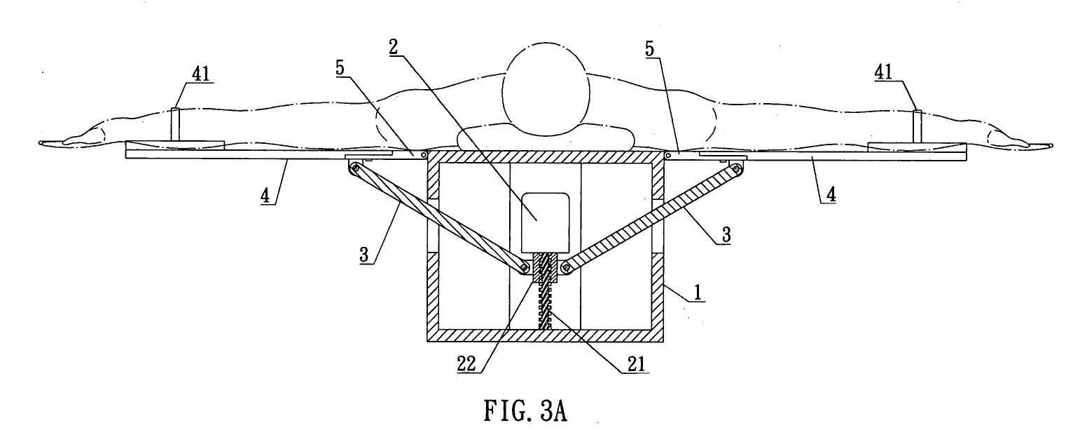

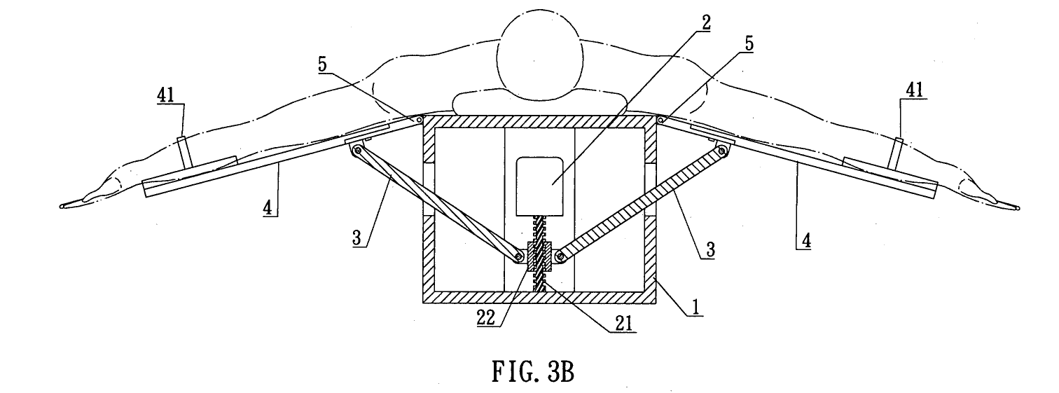

Referring to 3-A, when the user naturally supinates and spreads two arms on the upper extent of the swinging appendage 4 such that both are retained in position by protective sleeves 41, the user controls the forward/reverse rotation and halting of the said speed reduction motor 2 by means of a handheld remote controller, thereby controlling the swing angle of the said swinging appendages 4; as such, referring to FIG. 3-B, the said speed reduction motor 2 powers the screw rod 21 into rotation and if the sleeve 22 shifts downward, then the support rods 3 are tugged, lowering the swinging appendages 4 via the pivoting axis of the hinge 5, which naturally results in the downward movement of the arms spread out on the swinging appendages 4; when the user feels that the desired limit of descent has been reached, the speed reduction motor 2 is controlled to halt its operation, following which the speed reduction motor 2 is controlled to reverse its rotation, causing the sleeve 22 to shift upward and the support rods 3 to elevate the swinging appendages 4, thereby raising and lowering of the arms along with the swinging appendages 4 to stretch the circulatory system of the arms, while also providing for chest enlargement and respiratory exercise.

Additionally, the articulatory accent and descent limits of the swinging appendages 4 are indexed relative to the maximum travel limit of the sleeve 22 and respectively set by limiting switches or other circuit control methods (not claimed by the invention herein and, therefore, not elaborated) that control the speed reduction motor 2 to automatically stop or reverse rotational direction and thereby effectively enable automatically driven operation.

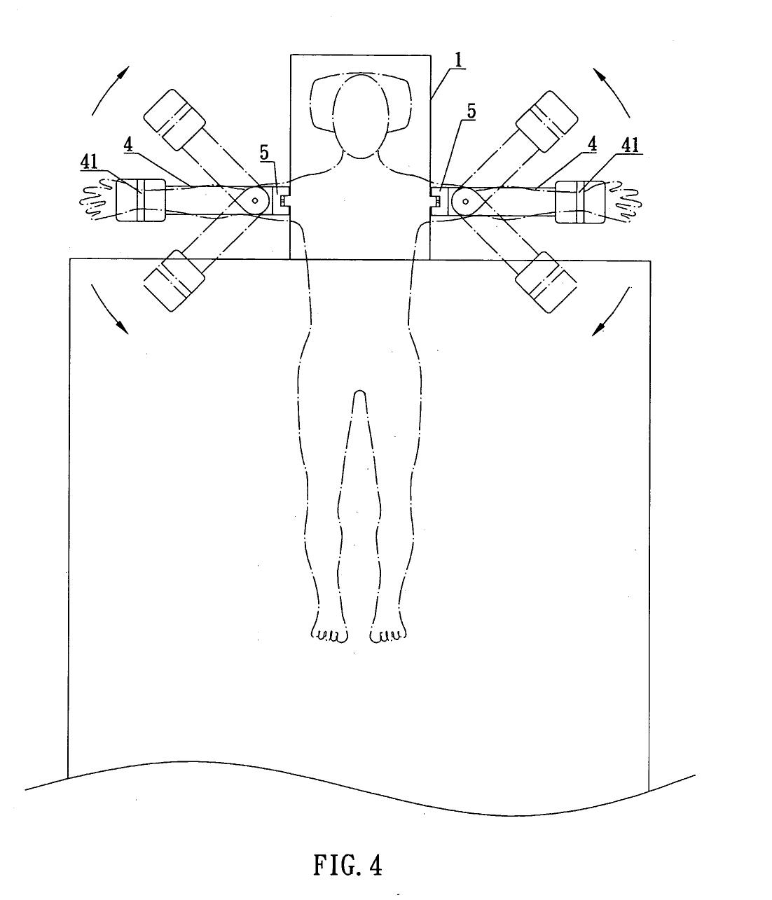

Referring to FIG. 4, the said swinging appendages 22 are movably disposed on the hinges 5 to provide for the adjustment of the swinging appendages 22 to the desired angle of horizontal posturing, thereby effectively providing for stretching the circulatory system of the arms at different positions.

1. An arm circulation system stretching, recuperative chest enlargement and respiration assistance apparatus, the features of which are:
The said apparatus body has an internally installed speed reduction motor, a sleeve is positioned on its driven screw rod, and a support rod is movably linked to each of the two sides of the said sleeve and, furthermore, each said support rod is extended and movably coupled to a swinging appendage, each said swinging appendage is affixed onto a hinge, and the said two hinges are each mounted on the two sides of the said apparatus body such that the said speed reduction motor rotates and controls the said sleeve to drive the said support rods, thereby raising and lowering the said swinging appendages to stretch the circulatory system of the arms, while also providing for chest enlargement and respiratory exercise.

2. As mentioned in claim 1 of the arm circulation system stretching, recuperative chest enlargement and respiration assistance apparatus of the invention herein, the said swinging appendages are movably disposed on the said hinges to provide for the adjustment of the said swinging appendages to the desired angle of horizontal posturing, thereby effectively providing for stretching the circulatory system of the arms at a range of different angles.
